(19) United States
(12) Patent Application Publication
(10) Pub. No.: US 2015/0094875 A1
(43) Pub. Date: Apr. 2, 2015

(54) Temperature-Controlled Storage Module that Cools Memory Prior to a Data Burst

(71) Applicants: Yacov Duzly, Raanana (IL); Amir Shaharabany, Kochav Yair (IL); Alon Marcu, Tel Mond (IL)

(72) Inventors: Yacov Duzly, Raanana (IL); Amir Shaharabany, Kochav Yair (IL); Alon Marcu, Tel Mond (IL)

(21) Appl. No.: 14/041,844

(22) Filed: Sep. 30, 2013

(51) Int. Cl. G05D 23/19; G06F 3/06

(52) U.S. Cl. CPC G05D 23/1919; G06F 3/0614; G06F 3/0659; G06F 3/0679
USPC 700/300

(57) ABSTRACT

A temperature-controlled storage module is disclosed that cools memory prior to a data burst. In one embodiment, a storage module is provided comprising a memory, a temperature sensor, a thermoelectric cooler, and a controller. The controller determines that a host in communication with the storage module is about to send a burst of data and then activates the thermoelectric cooler to cool the memory. The controller can determine that the host is about to send a burst of data either from a notification from the host or by making an inference based on write activity from the host over a period of time. This enables higher parallelism during the burst, hence improving the burst's performance.

### BACKGROUND

The behavior of memories, such as NAND flash memories, is often very dependent on its operating and storage temperature. In high temperatures, the endurance is improved due to better annealing, but data retention is degraded according to the Arrhenius equation. In very low temperatures, other effects are prominent. Memory designers take this dependence into consideration to produce a memory that operates in a wide range of temperatures, which provides a compromise between data retention, endurance, and other memory characteristics. However, operating at wide range of temperatures is a compromise, as certain characteristics are better suited for a smaller temperature range tailored to their specific operations.

Temperature-related issues affect storage modules is other ways as well. For example, increases in read and write performance often require multiple memory dies or plane parallelism to achieve the desired performance. Current consumption and heat dissipation are two major factors that may limit the amount of parallelism in a storage module. Even if there is no limitation on current consumption and the host can guarantee a required housing temperature, there can still be a heat problem due to the passive heat resistance between the memory dies and the housing. Moreover, typical host access to the storage module is often in short, intensive demands for data known as bursts. During the time of a burst, more demand is placed on the memory, which can increase the temperature of the memory to levels at or above the maximum operating temperature rating.

### Overview

Embodiments of the present invention are defined by the claims, and nothing in this section should be taken as a limitation on those claims.

By way of introduction, the below embodiments relate to a temperature-controlled storage module that cools memory prior to a receiving of data burst. In one embodiment, a storage module is provided comprising a memory, a temperature sensor, a thermoelectric cooler, and a controller. The controller determines that a host in communication with the storage module is about to send a burst of data and then activates the thermoelectric cooler to cool the memory. The controller can determine that the host is about to send the data burst either from a notification from the host or by making an inference based on write activity from the host over a period of time. This enables higher parallelism during the burst, hence improving the burst's performance.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary storage module of an embodiment.

FIG. 2A is a block diagram of a host of an embodiment, where the exemplary storage module of FIG. 1 is embedded in the host.

FIG. 2B is a block diagram of the exemplary storage module of FIG. 1 removably connected to a host, where the storage module and host are separable, removable devices.

FIG. 3 is a flow chart of a method of an embodiment for controlling the temperature of a storage module.

FIG. 4 is a diagram of a circuit of an embodiment for controlling the temperature of a storage module.

FIG. 5 is a diagram of a storage module of an embodiment with a single thermoelectric cooler.

FIG. 6 is a diagram illustrating heat transfer from the storage module of FIG. 5.

FIG. 7 is a diagram of a storage module of an embodiment with two thermoelectric coolers.

FIG. 8 is a diagram illustrating heat transfer from the storage module of FIG. 7.

FIGS. 9A and 9B are illustrations of an embodiment in which memory dies are cooled prior to a burst period.

FIG. 10 is an illustration of a storage module of another embodiment.

FIG. 11 is an illustration of a prior art thermoelectric cooler.

### DETAILED DESCRIPTION OF THE PRESENTLY PREFERRED EMBODIMENTS

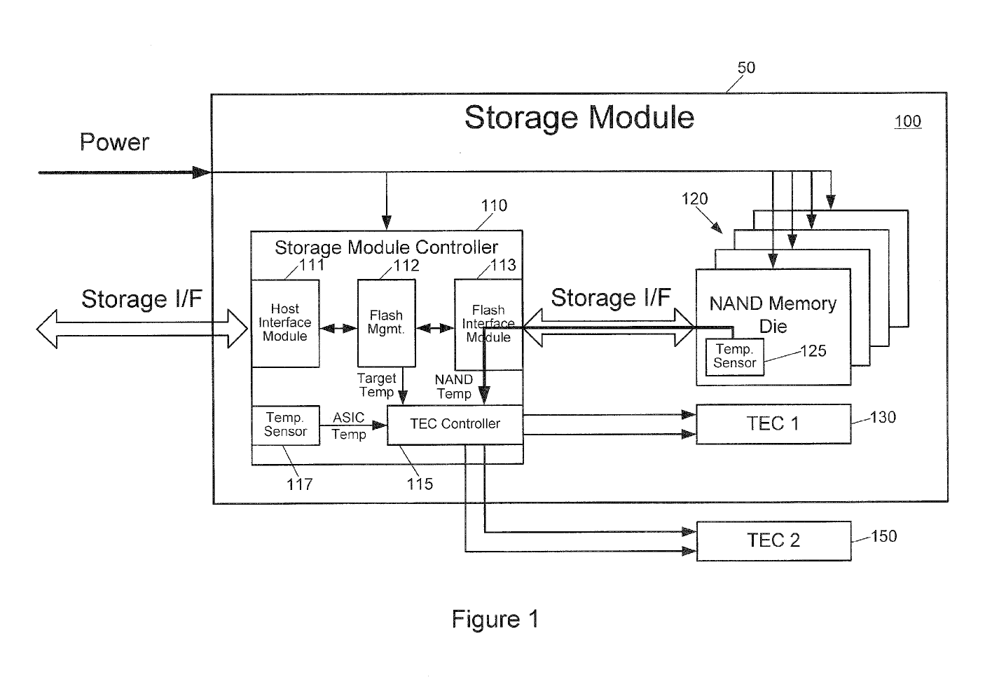

Turning to the drawings, FIG. 1 is a diagram of a storage module 100 of an embodiment. As illustrated in FIG. 1, the storage module 100 comprises a controller 110 in communication with one or more memory dies 120 having in or on them a temperature sensor 125. As used herein, the phrase “in communication with” could mean directly in communication with or indirectly in communication with through one or more components, which may or may not be shown or described herein. FIG. 1 shows the memory dies 120 as NAND memory dies; however, other memory technology can be used. Also, the memory 120 can be one-time programmable, few-time programmable, or many-time programmable. The memory 120 can also use single-level cell (SLC), multiple-level cell (MLC), triple-level cell (TLC), or other memory technologies, now known or later developed. Also, the memory 120 can be two-dimensional or three-dimensional (e.g., Bit Cost Memory (BiCS)) and can be a multi-chip package or a single-chip package.

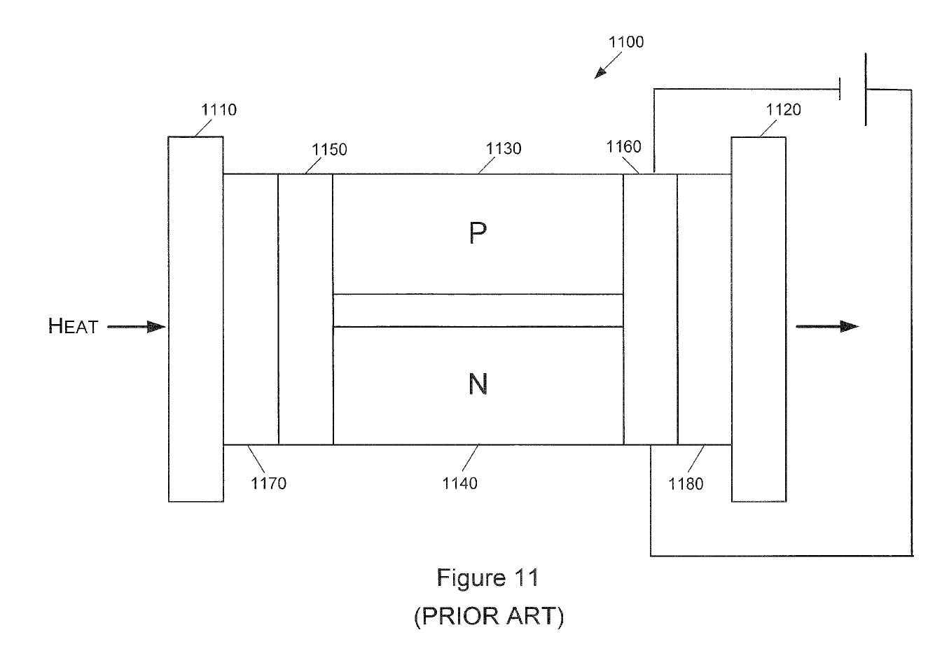

The storage module 100 in FIG. 1 also comprises a temperature transfer device, such as a thermoelectric cooler (TEC) 130. (In one embodiment, the controller 110, memory die(s) 130, and TEC 130 are all stacked on a substrate, and all of those components are housed in an integrated circuit package 50.) A thermoelectric cooler is a solid-state device that uses the Peltier effect to create a heat flux between the junction of two different types of materials. In general, thermoelectric coolers operate by the Peltier effect. As shown in FIG. 11, one type of prior art thermoelectric cooler 1100 (other types can be used) has two sides, and when DC current flows through the cooler 1100, it brings heat from one side of the cooler 1100 to the other side. This results in one side getting cooler while the other side gets hotter. The side that gets cooler is attached to a cooling plate 1110, and the side that gets hotter is attached to a heat sink 1120. The thermoelectric cooler 1100 can be made from two unique semi-conductors (one p-type 1130 and one n-type 1140) with different electron densities. The semi-conductors 1130, 1140 are placed thermally in parallel to each other and electrically in series and then joined with thermally-conducting plates 1150, 1160 on each side (with insulators 1170, 1180 next to them). When a voltage is applied to the free ends of the two semiconductors 1130, 1140, there is a flow of DC current across the junction of the semi-conductors 1130, 1140 causing a temperature difference. The side with the cooling plate 1110 absorbs heat, which is then moved to the other side with the heat sink 1112.

Because a thermoelectric cooler is a heat pump that transfers heat from one side of the device to the other with consumption of electrical energy, a thermoelectric cooler can be used either for cooling (refrigeration) or heating depending on the direction of the current. As will be discussed below, in these embodiments, the thermoelectric cooler is used to cool or heat the memory dies 120 in order to keep a desired temperature. Because cooling and heating requires extra current from a power supply, such power requirements should be taken into considerations when designing a system for use with the storage module 100 to ensure adequate power is being supplied to the storage module 100. Due to the power requirements, the storage module 100 may find particular use where there is no shortage of power, such as in a solid-state drive or in a host device (e.g., a set-top box) with embedded memory. However, these embodiments can also be used with removable storage devices. For example, the storage module 100 can receive power from an outside source to power the controller 110 and memory 120 or can have its own power source (e.g., a battery). Further, as will be described below, there can be additional TECs internal to or external to (such as (TEC 2) 150) the storage module 100. The use of the thermoelectric cooler 130 will be discussed in detail below.

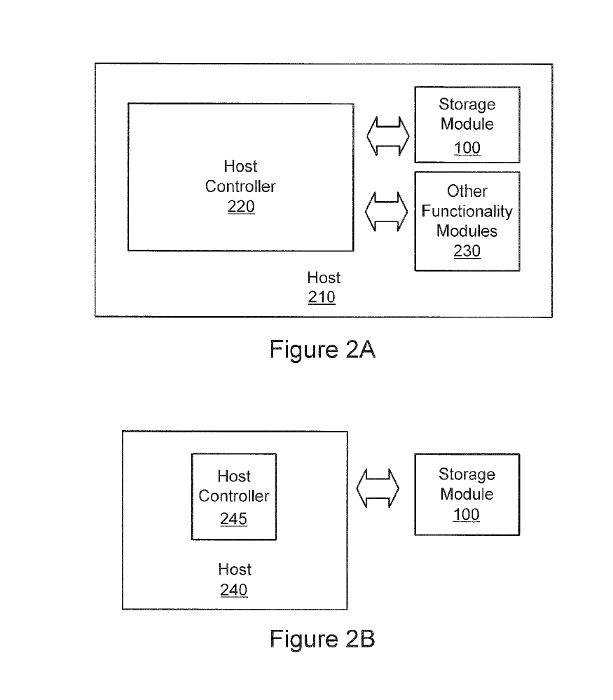

As shown in FIG. 2A, the storage module 100 can be embedded in a host 210 having a host controller 220. That is, the host 210 embodies the host controller 220 and the storage module 100, such that the host controller 220 interfaces with the embedded storage module 100 to manage its operations. For example, the storage module 100 can take the form of an iNAND™ eSD/eMMC embedded flash drive by SanDisk Corporation. The host controller 220 or another component in the host 210 would supply the storage module 100 with power. The host controller 220 can interface with the embedded storage module 100 using a storage interface such as eMMC, UFS, USB, SATA, SAS, SCSI, fiber channel, or PCIe, for example. The host 210 can take any form, such as, but not limited to, a solid state drive (SSD), a hybrid storage device (having both a hard disk drive and a solid state drive), a memory caching system, a mobile phone, a tablet computer, a digital media player, a game device, a personal digital assistant (PDA), a mobile (e.g., notebook, laptop) personal computer (PC), or a book reader. As shown in FIG. 2A, the host 210 can include optional other functionality modules 230. For example, if the host 210 is a mobile phone, the other functionality modules 230 can include hardware and/or software components to make and place telephone calls. As another example, if the host 210 has network connectivity capabilities, the other functionality modules 230 can include a network interface. Of course, these are just some examples, and other implementations can be used. Also, the host 210 can include other components (e.g., an audio output, input-output ports, etc.) that are not shown in FIG. 2A to simplify the drawing.

As shown in FIG. 2B, instead of being an embedded device in a host, the storage module 100 can have physical and electrical connectors that allow the storage module 100 to be removably connected to a host 240 (having a host controller 245) via mating connectors. The host controller 245 or another component in the host 240 could supply the storage module 100 with power, or power could be provided to the storage module 100 from another device. In this embodiment, the storage module 100 is a separate device from (and is not embedded in) the host 240. The storage module 100 can be, for example, a removable memory device, such as a Secure Digital (SD) memory card, a microSD memory card, a Compact Flash (CF) memory card, or a universal serial bus (USB) device (with a USB interface to the host), and the host 240 is a separate device, such as a mobile phone, a tablet computer, a digital media player, a game device, a personal digital assistant (PDA), a mobile (e.g., notebook, laptop) personal computer (PC), or a book reader, for example.

In FIGS. 2A and 2B, the storage module 100 is in communication with a host controller 220 or host 240 via storage interface. The storage interface can take any suitable form, such as, but not limited to, eMMC, UFS, UBS, SATA, SAS, SCSI, fiber channel, or PCIe, for example. The interface in the storage module 110 conveys memory management commands from the host controller 220 (FIG. 2A) or host 240 (FIG. 2B) to the controller 110, and also conveys memory responses from the controller 110 to the host controller 220 (FIG. 2A) or host 240 (FIG. 2B). Also, it should be noted that when the storage module 110 is embedded in the host 210, some or all of the functions described herein as being performed by the controller 110 in the storage module 100 can instead be performed by the host controller 220.

Returning to FIG. 1, the controller 110 comprises a host interface module 111, a flash management module 112, a flash interface module 113, a TEC controller 115, and an optional temperature sensor 117. The controller 110 can be implemented in any suitable manner and can be a controller from SanDisk or from another vendor. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. One or more of the TEC controller 115 and various modules 111, 112, 113, 115 can be implemented in hardware or can be implemented by computer readable program code (stored in the memory 120 or another location) executed by a central processing unit (CPU) of the controller 110.

The host interface module 111 receives host commands (e.g., read and write commands) through a storage interface, such as eMMC or any of the other interface listed above, for example. The flash management module 112 is firmware executed by the controller 110 to handle host requests and translate them to NAND flash operations, and the flash interface module 113 performs memory operation according to instructions provided by the flash management module 112.

The TEC controller 115 is used in conjunction with the TEC 130 to provide power to the TEC 130 to heat or cool the NAND memory dies 120, as appropriate. As discussed above, the behavior of memories, such as NAND flash memories, is often very dependent on temperature. In high temperatures, the endurance is improved due to better annealing, but data retention is degraded. In very low temperatures, other effects are prominent. Memory designers take this dependence into consideration to produce a memory that operates in a wide range of temperatures, but using a wide range of temperatures is often not optimal, as certain characteristics are better suited for a smaller temperature range tailored to their specific operations.

This embodiment can be used to set the temperature of the storage module 100 at a temperature best suited for its particular operation. Further, with this embodiment, the end user of the storage module 100 can be given the ability to control the storage module's temperature to emphasize a desired system or memory (e.g., NAND) characteristic, such as endurance or data retention. For example, with some memory technologies, a temperature range of 0 C to 40 C is preferred for high data retention, while a temperature range of 55 C to 85 C is preferred for high endurance.

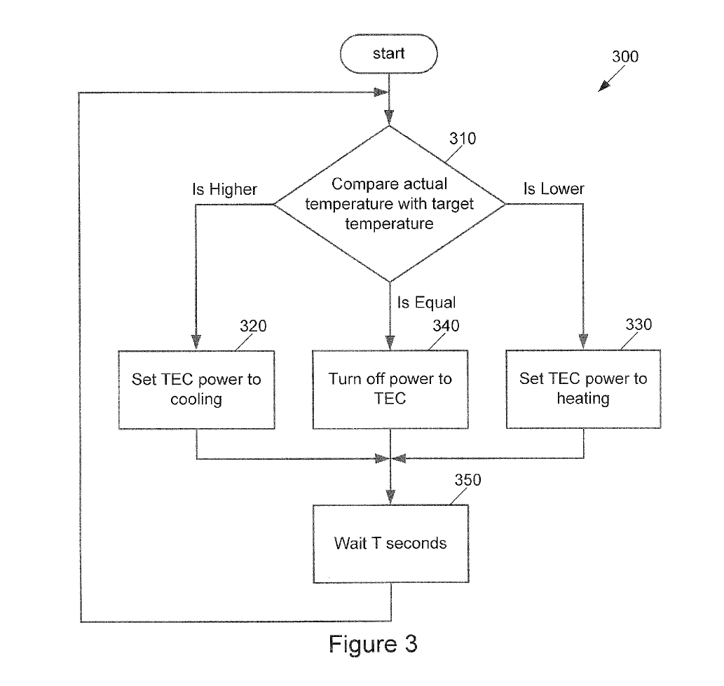

In operation, the TEC controller 115 compares a temperature reading from the temperature sensor 125 to a target temperature. The target temperature can be provided to the TEC controller 115 by the flash management module 112, and the TEC controller 115 can obtain the temperature reading from the temperature sensor 125 through a NAND command. If the temperature reading from the temperature sensor 125 differs from the target temperature, the TEC controller 115 can activate the TEC 130 to either cool or heat the memory 120, as appropriate. This operation is shown in the flow chart 300 in FIG. 3.

As shown in FIG. 3, the TEC controller 115 compares the temperature reading from the temperature sensor 125 with a target temperature (act 310). The target temperature can be predetermined (fixed) or adjustable by a user of the storage module 100. For example, the user can change the temperature through a storage protocol command to achieve a desired memory characteristic. Also, the target temperature can be a single temperature (e.g., 55 C) or a temperature range (e.g., 55 C to 85 C). If the temperature reading from the temperature sensor 125 is higher than the target temperature, the TEC controller 115 sets the power of the TEC 130, so that it cools the memory dies 120 (act 320). If the temperature reading from the temperature sensor 125 is lower than the target temperature, the TEC controller 115 sets the power of the TEC 130, so that it heats the memory dies 120 (act 330). If the temperature reading from the temperature sensor 125 is equal to the target temperature, the TEC controller 115 turns off the power of the TEC 130, so that it neither heats nor cools the memory dies 120 (act 340). After waiting a period of time (act 350), the method can start over again.

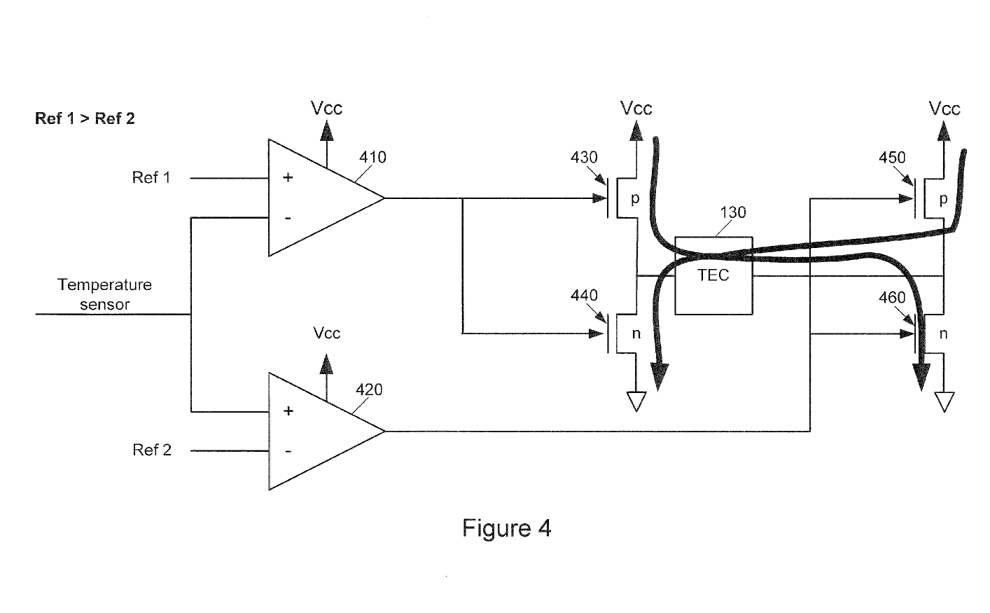

FIG. 4 is a diagram of a circuit of an embodiment for controlling the temperature. In this example, the target temperature is a range between Ref 1 (e.g., 55 C) and Ref 2 (e.g., 85 C). As shown in FIG. 4, this circuit comprises two op amps 410, 420, a first set of MOSFETs 430, 440 on one side of the TEC 130, and a second set of MOSFETs 450, 460 on the other side of the TEC 130. In each pair, only one MOSFET is conducting at a time. In operation, the first op amp 410 compares the temperature reading from the temperature sensor 125 to the first reference temperature. If the temperature reading is higher than that reference temperature, voltage is applied to the first set of MOSFETs 430, 440 (430 is conducting) to push current through the TEC 130 to activate a cooling operation. The second op amp 420 compares the temperature reading from the temperature sensor 125 to the second reference temperature. If the temperature reading is lower than that reference temperature, voltage is applied to the second set of MOSFETs 450, 460 to pull current through the TEC 130 to activate a heating operation. In this way, the TEC 130 can maintain a fixed temperature or temperature range on the memory dies 120.

There are many configurations and alternatives to these embodiments. For example, in the embodiment above, the temperature sensor 125 was part of the memory dies 120. However, instead of or in addition to the temperature sensor 125 in the memory dies 120, the storage module 110 can have a temperature sensor 117 in the ASIC of the controller 110 or in another location in the storage module 100 (see FIG. 1). If multiple temperature sensors are used, the TEC controller 115 can use the individual readings separately (e.g., taking the highest/lowest reading) or use them together in some fashion (e.g., average the readings, apply different weights to the readings, etc.).

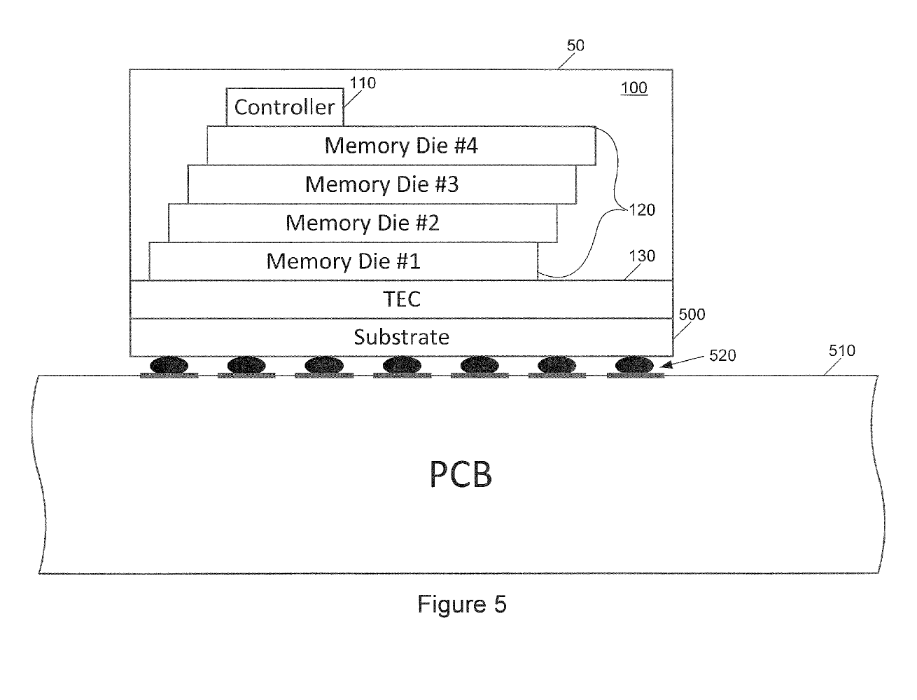

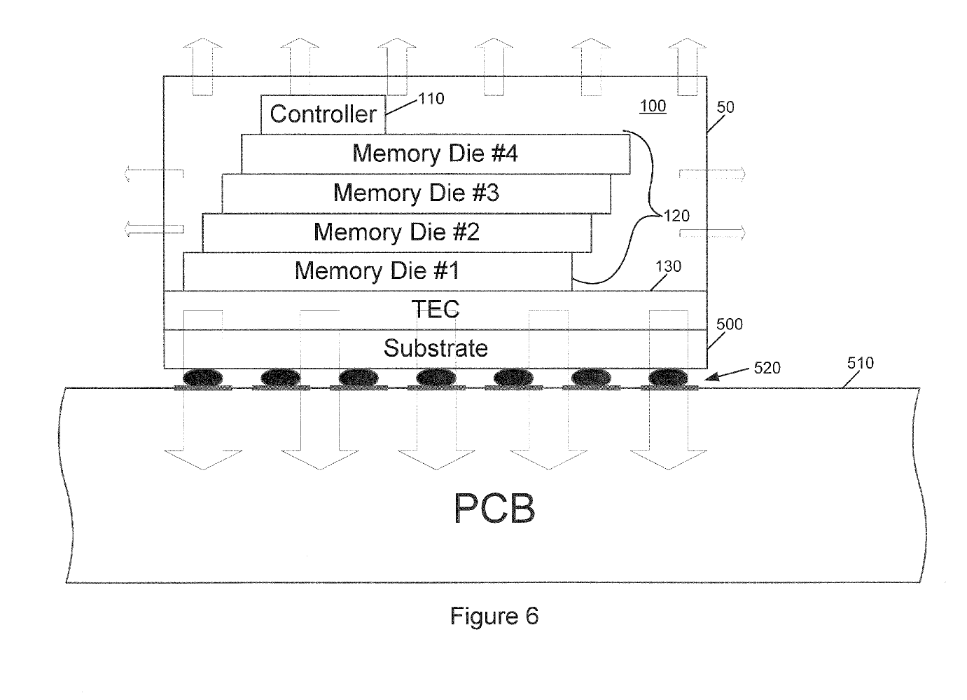

The TEC 130 can be located in any suitable location in the storage module 100, and FIGS. 5-8 illustrate some exemplary configurations. In FIG. 5, the controller 110, memory dies 120, and TEC 130 are all stacked on a substrate 500, with the TEC 130 being located between the substrate 500 and the first memory die in the stack of memory dies 120. The substrate 500 is thermally and electrically coupled to a printed circuit board 510 via a plurality of solder balls 520. The substrate 500 and solder balls 520 can be part of a ball grid array (BGA) package, such as the HL-PBGA package from Intel. FIG. 6 shows the heat transfer from the storage module 100 of FIG. 5. As can be seen in FIG. 6, although there is some heat flow from the sides and top of the memory dies 130, most of the heat is transferred from the memory dies 120 through the TEC 130 and dissipated through the printed circuit board 510 via the substrate 500 and solder balls 520.

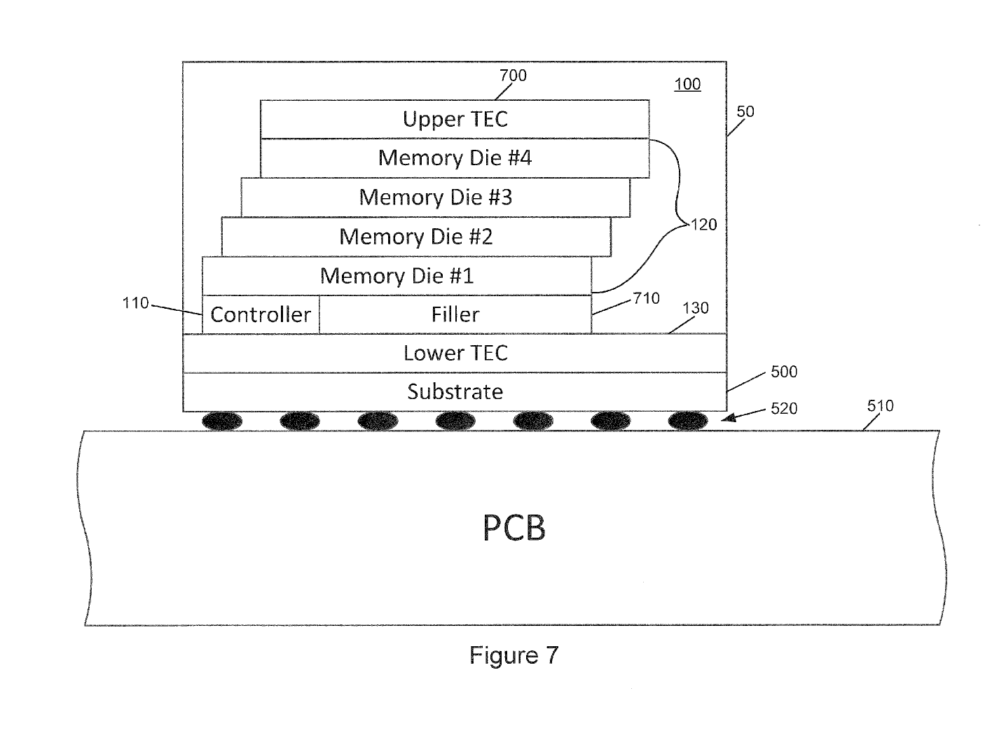

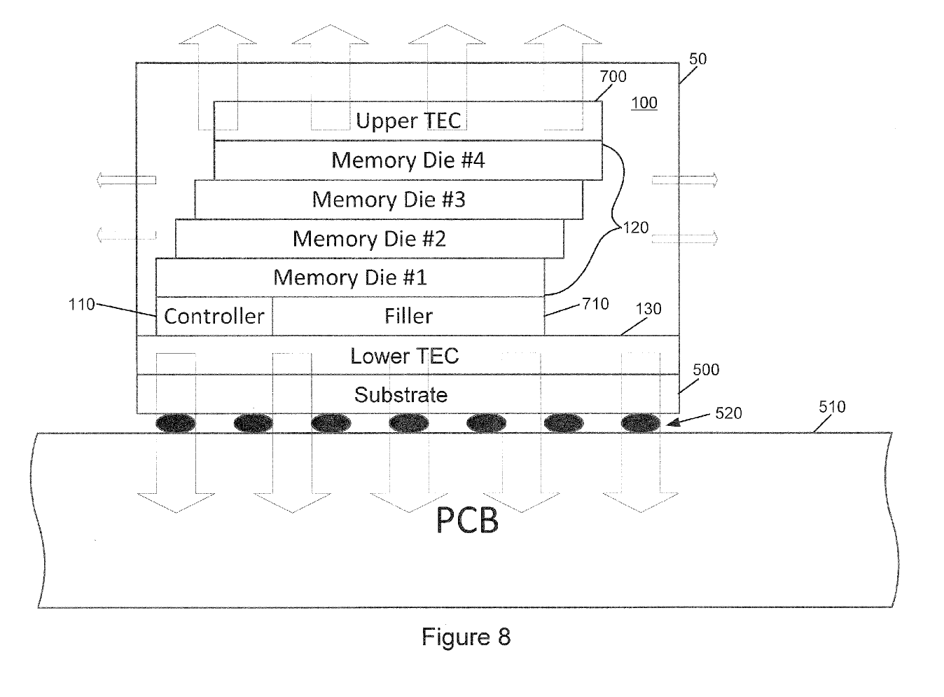

If there is a significant temperature gradient between the closest die to the TEC 130 and the farthest, additional heating/cooling may be needed, and one or more additional TECs can be added to the storage module 100. For example, in FIG. 7, a second TEC 700 is added to the top of the stack, so that the memory dies 120 are sandwiched between the two TECs 130, 700 so as to isolate the internal dies 120 from the outside temperature. As compared to the configuration shown in FIGS. 5 and 6, the controller 110 is moved from the top of the memory dies 120 to the bottom, and a thermally conductive filler 710 is added to fill the void. FIG. 8 shows the heat transfer of this configuration, where the two TECs 130, 700 dissipate heat from the top and bottom of the storage module 100.

It should be noted that while the TEC(s) were internal to the packaging 50 (housing) of the storage module 100 in the above examples, a TEC external to the packaging 50 (see FIG. 1) can be used instead of or in addition to the TEC(s) internal to the packaging 50. This alternative may be preferred in situations where the storage module 100 is being operated in an unusually warm or cold environment. Since the external TEC 150 is located outside of the storage module 100 and not subject to the space and other constraints, larger devices for cooling or heating (e.g., standard refrigeration techniques) can be used.

In the above example, it was assumed that a target temperature was desired for the entire memory die 120 to optimize one NAND characteristic. However, there may be more than one NAND characteristic for which different target temperatures are desired. For example, it may be desired to design a storage module that has very long data retention for user content and very high endurance for a single-level cell (SLC) cache, both of which cannot be optimally achieved at the same temperature. To address this situation, a memory die can be divided into a plurality of regions, with each region being associated with a different target temperature. The TEC can also be divided into a corresponding plurality of regions that are independently controlled by the TEC controller. So, for the above example, advantage can be taken of the planarity of the TEC and memory to divide the memory and TEC into two separate independent units. The first TEC region can heat the cache blocks and guarantee high endurance, while, at the same time, the second TEC region can cool the user content blocks (intact blocks) and guarantee high data retention. In this way, a non-uniform temperature profile across the TEC is used to achieve different temperature conditions for different memory uses (here, caching and storage of intact blocks).

In another embodiment, temperature control of a storage module is used to prevent the temperature of the memory from rising to levels at or above the maximum operating temperature rating when a host is sending a burst of data. As used herein, a “burst of data” refers to a relatively-high load period by the host (i.e., a period in which the host is writing a relatively-high amount of data and/or issues a relatively-high number of write commands). That is, bursts are periods of time when a higher-than-average performance by the storage module 100 is required to satisfy the write activity of the host. In many situations, the host is operating in a near-idle mode most of the time and occasionally sends a burst of data when there is a high demand for data (e.g., when a user activates a host device (such as a camera or mobile phone) or when an email arrives with a large attachment). The typical duration of a burst of data is a few seconds, and the required performance is higher than while in other modes. This short and intensive demand for data can increase the temperature of the memory to dangerous levels and can negatively affect the system's responsiveness, especially when multiple die parallelism is used to meet increasing read and write performance requirements.

To address this concern, in another embodiment (which can be used together with or separately from the embodiments discussed above, the TEC controller 115 determines that the host is about to send a data burst and then activates the TEC 130 to cool the memory 120 prior to the receiving of the data burst.

The TEC controller 115 can determiner that the host is about to send a data burst in any suitable manner. For example, the TEC controller 115 can receive a notification (e.g., via a storage protocol command) that the host is about to send a data burst. This notification can expressly indicate that a data burst is upcoming or can contain some other message that is indicative of an upcoming burst (e.g., that the host buffer is full). As another example, the storage module 100 can have an internal detection mechanism for inferring when the burst is about to occur based on host activity. For example, the storage module 100 can determine if the write activity of the host over a time period exceeds a threshold. The write activity can be, for example, an amount of data received from the host to be written in the storage module 100 and/or a number of write commands received from the host (e.g., the number of input/output operations per second (“IOPS”)). It is preferred that the time period over which the storage module 100 assesses whether there is a burst of data be small enough to enable fast detection of the data burst but large enough to eliminate noise in the detection (e.g., 100-200 msec). Additionally, the threshold against which to measure write activity can be static (an absolute number) (e.g., data being received from the host at a rate of 40 MB/sec and/or 200-2,000 write commands being received from the host over a 100-200 msec window) or dynamic (a relative number) (e.g., as a percentage based on previous write activity of the host (over the same or different time period) in a weighted or unweighted manner). If the storage module 100 is designed to both accept a notification from the host and to have an internal detection mechanism, rules can be set to determine which indication to follow if there is a clash (e.g., the notification from the host would trigger the cooling operation, and the later indication from the internal detection mechanism would be ignored).

Irrespective of the method used, when the TEC controller 115 determines that the host is about to send the burst, the TEC controller 115 activates the TEC 130 to cool the memory 120 prior to the host sending the burst. A target low temperature can be set, or the TEC 130 can just run until turned off. This “pre-cools” the memory 120 to account for the heat to be generated when the host sends the burst. The TEC controller 115 can determine when to stop cooling the memory 120 either in response to a notification from the host or by making an inference from the write activity of the host.

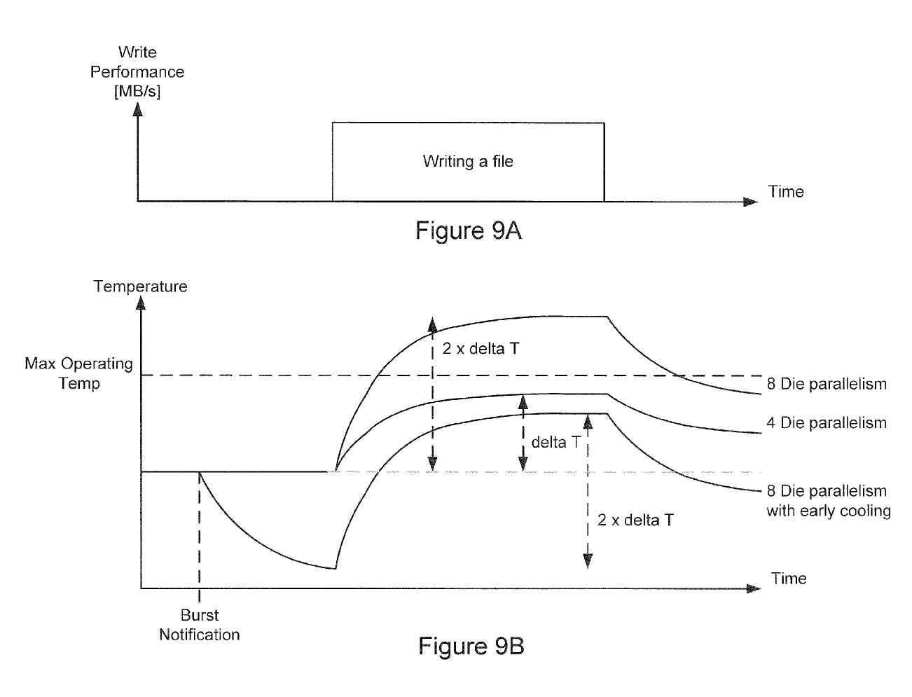

FIGS. 9A and 9B illustrate this embodiment. As shown in FIG. 9A, before and after the data burst, the host is in an idle mode. As shown in FIGS. 9A and 9B, before the host sends the data burst, the memory 120 is operating at a constant temperature below the maximum operating temperature. In the situation where four-die parallelism is used, the temperature of the memory 120 rises when the host sends a burst of data and peaks at a temperature of a delta T above the temperature of the normal operation condition. As shown in FIG. 9B, this peak temperature is below the maximum operating temperature but is still relatively high. However, when eight-die parallelism is used, a temperature rise of 2× delta T is encounter during the burst, which raises the temperature of the memory 120 above the maximum operating temperature and can result in damage to the storage module 100.

Using the method of this embodiment, when the storage module 100 receives a burst notification from the host, it begins to cool the memory 120 before burst is received. This lowers the temperature floor of the memory 120, so that even with a temperature rise of 2× delta T, the temperature is lower than the maximum operating temperature.

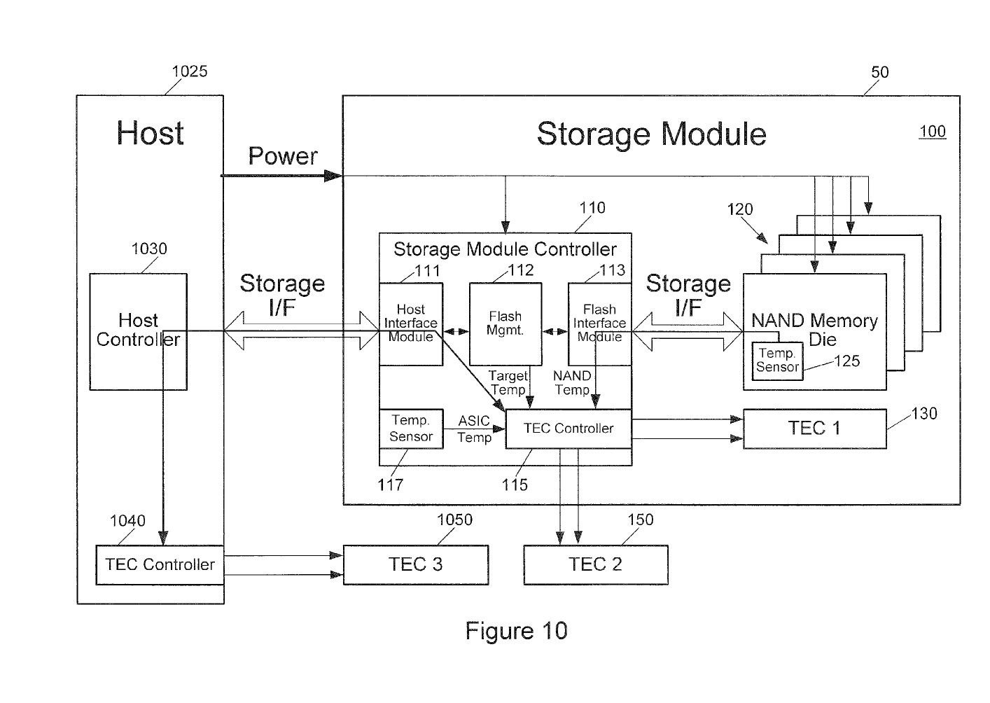

There are many alternatives that can be used with this embodiment. For example, instead of stopping the cooling of the memory at the end of the burst, the TEC controller 115 can provide further cooling after the end of the burst to prepare for the next burst, especially if the next burst will occur a short time (e.g., 15 seconds) later or when the start of the burst is detected internally by the storage device 100 (since the internal detection may cause the cooling to start after the burst has started). In another alternate embodiment (shown in FIG. 10), instead of or in addition to the TEC controller 115 in the storage module 100 controlling one or more TECs, the host 1025 can contains its own TEC controller 1040 and one or more of its own TECs 1050 external to the storage module package 50 (but preferably close to it). As another alternative, the controller 30 in the host 1025 can send instructions to the TEC controller 115 in the storage module 100 (e.g., via storage protocol commands) to operate the TEC(s) 130, 150 in and around the storage module 100. Conversely, the TEC controller 115 in the storage module 100 can instruct the TEC controller 1040 in the host 1025 to operate its TEC 1050.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

1. A storage module comprising:
a memory;
a temperature sensor;
a thermoelectric cooler; and
a controller in communication with the memory, the temperature sensor, and the thermoelectric cooler, wherein the controller is configured to:
determine that a host in communication with the storage module is about to send a data burst, wherein prior to receiving the data burst, a temperature of the storage module is below a threshold temperature; and
activate the thermoelectric cooler to pre-cool the memory prior to receiving the data burst, wherein pre-cooling the memory offsets heat that will be generated after the data burst is received and allows the temperature of the storage module to remain below the threshold temperature.

2. The storage module of claim 1, wherein the controller determines that the host is about to send the data burst from a notification from the host.

3. The storage module of claim 1, wherein the controller determines that the host is about to send the data burst through inference based on write activity from the host.

4. The storage module of claim 3, wherein the write activity from the host comprises one or both of the following: (i) an amount of data received from the host to be written in the memory and (ii) a number of write commands received from the host.

5. The storage module of claim 1, wherein the controller is further configured to:
determine that the host is no longer sending the data burst; and
deactivate the thermoelectric cooler.

6. The storage module of claim 5, wherein the controller determines that the host is no longer sending the data burst from a notification from the host.

7. The storage module of claim 5, wherein the controller determines that the host is no longer sending the data burst through inference based on write activity from the host.

8. The storage module of claim 7, wherein the write activity from the host comprises one or both of the following: (i) an amount of data received from the host to be written in the memory and (ii) a number of write commands received from the host.

9. The storage module of claim 1, wherein the controller is further configured to continue to cool the memory after host sends the data burst to prepare for a next time the host sends a data burst.

10. The storage module of claim 1, wherein the controller is further configured to receive a command from the host's controller to activate the thermoelectric cooler.

11. The storage module of claim 1, wherein the controller is further configured to send a command to the host's controller to activate a thermoelectric cooler controlled by the host.

12. The storage module of claim 1, wherein the memory comprises a plurality of memory dies, wherein the storage module comprises an additional thermoelectric cooler, and wherein the plurality of memory dies are located between the thermoelectric cooler and the additional thermoelectric cooler.

13. The storage module of claim 1 further comprising packaging housing the controller and the memory, and wherein the thermoelectric cooler is external to the packaging.

14. The storage module of claim 1, wherein the storage module is embedded in the host.

15. The storage module of claim 1, wherein the storage module is removably connected to the host.

16. The storage module of claim 1, wherein the memory is a NAND memory.

17. The storage module of claim 1, wherein the storage module is a solid-state drive.

18. A method for cooling a storage module prior to a data burst, the method comprising:
performing the following in a storage module having a memory, a temperature sensor, and a thermoelectric cooler:
determining that a host in communication with the storage module is about to send a data burst, wherein prior to receiving the data burst, a temperature of the storage module is below a threshold temperature; and
activating the thermoelectric cooler to pre-cool the memory prior to receiving the data burst, wherein pre-cooling the memory offsets heat that will be generated after the data burst is received and allows the temperature of the storage module to remain below the threshold temperature.

19. The method of claim 18, wherein the method determines that the host is about to send the data burst from a notification from the host.

20. The method of claim 18, wherein the method determines that the host is about to send the data burst through inference based on write activity from the host.

21. The method of claim 20, wherein the write activity from the host comprises one or both of the following: (i) an amount of data received from the host to be written in the memory and (ii) a number of write commands received from the host.

22. The method of claim 18 further comprising:
determining that the host is no longer sending the data burst; and
deactivating the thermoelectric cooler.

23. The method of claim 22, wherein the method determines that the host is no longer sending the data burst from a notification from the host.

24. The method of claim 22, wherein the method determines that the host is no longer sending the data burst through inference based on write activity from the host.

25. The method of claim 24, wherein the write activity from the host comprises one or both of the following: (i) an amount of data received from the host to be written in the memory and (ii) a number of write commands received from the host.

26. The method of claim 18 further comprising:
continuing to cool the memory after host sends the data burst to prepare for a next time the host sends a data burst.

27. The method of claim 18 further comprising:
receiving a command from the host's controller to activate the thermoelectric cooler.

28. The method of claim 18 further comprising:
sending a command to the host's controller to activate a thermoelectric cooler controlled by the host.

29. The method of claim 18, wherein the memory comprises a plurality of memory dies, wherein the storage module comprises an additional thermoelectric cooler, and wherein the plurality of memory dies are located between the thermoelectric cooler and the additional thermoelectric cooler.

30. The method of claim 18, wherein the storage module further comprises packaging housing the controller and the memory, and wherein the thermoelectric cooler is external to the packaging.

31. The method of claim 18, wherein the storage module is embedded in the host.

32. The method of claim 18, wherein the storage module is removably connected to the host.

33. The method of claim 18, wherein the memory is a NAND memory.

34. The method of claim 18, wherein the storage module is a solid-state drive.

35. The storage module of claim 1, wherein the memory is three-dimensional memory.

36. The method of claim 18, wherein the memory is three-dimensional memory.
